(19) United States
(12) Patent Application Publication
(10) Pub. No.: US 2024/0330767 A1
(43) Pub. Date: Oct. 3, 2024

(54) CO-DISTILLATION FOR MIXING SERVER-BASED AND FEDERATED LEARNING

(71) Applicant: Google LLC, Mountain View, CA (US)

(72) Inventors: Andrew Hard, Seattle, WA (US); Rajiv Mathews, Sunnyvale, CA (US)

(73) Assignee: Google LLC, Mountain View, CA (US)

(21) Appl. No.: 18/611,628

(22) Filed: Mar. 20, 2024

Related U.S. Application Data
(60) Provisional application No. 63/492,768, filed on Mar. 28, 2023.

(51) Int. Cl. G06N 20/00

(52) U.S. Cl. CPC G06N 20/00

(57) ABSTRACT

A method includes training a client machine learning (ML) model on client training data at a client device. While training the client ML model, the method also includes obtaining, from a server, server model weights of a server ML model trained on server training data, the server training data different that the client training data. While training the client ML model, the method also includes: transmitting, to the server, client model weights of the client ML model; updating the client ML model using the server model weights; obtaining, from the server, updated server model weights of the server ML model, the updated server model weights updated based on the transmitted client model weights; and further updating the client ML model using the updated server model weights.

### CROSS-REFERENCE TO RELATED APPLICATIONS

This U.S. patent application claims priority under 35 U.S.C. § 119 (e) to U.S. Provisional Application 63/492,768, filed on Mar. 28, 2023. The disclosure of this prior application is considered part of the disclosure of this application and is hereby incorporated by reference in its entirety.

### TECHNICAL FIELD

This disclosure relates to co-distillation for mixing server-based and federated learning.

### BACKGROUND

Federated learning of machine learning (ML) model(s) is an increasingly popular ML technique for training of ML model(s). In traditional federated learning, a local ML model is stored locally on a client device of a user, and a global ML model, that is a cloud-based counterpart of the local ML model, is stored remotely at a remote system (e.g., a cluster of servers). The client device, using the local ML model, can process user input detected at the client device to generate predicted output and can compare the predicted output to a ground truth output to generate a gradient using supervised learning techniques. Further, the client device can transmit the gradient to the remote system. The remote system can utilize the gradient, and optionally additional gradients generated in a similar manner at additional client devices, to update weights of the global ML model. Further, the remote system can transmit the global ML model, or updated weights of the global ML model, to the client device. The client device can then replace the local ML model with the global ML model, or replace the weights of the local ML model with the updated weights of the global ML model, thereby updating the local ML model.

Notably, the global ML model may be initially trained using a server data set at the remote system and fine-tuned using the federated learning framework in the manner described above. Put another way, the global ML model may be initially trained at the remote server with the server data set until the global ML is usable and then may be subsequently fine-tuned in a privacy-sensitive manner using client data that is more likely to be encountered during inference. However, ML models trained in this may be prone to catastrophic forgetting in that information learned from the server data set in the initial training may be abruptly forgotten when updating the weights of the global ML model based on gradients generated at client devices.

### SUMMARY

One aspect of the disclosure provides a computer-implemented method that when executed on data processing hardware causes the data processing hardware to perform operations that include training a client machine learning (ML) model on client training data at a client device. While training the client ML model, the operations also includes obtaining, from a server, server model weights of a server ML model trained on server training data, the server training data different that the client training data. While training the client ML model, the operations also include: transmitting, to the server, client model weights of the client ML model; updating the client ML model using the server model weights; obtaining, from the server, updated server model weights of the server ML model, the updated server model weights updated based on the transmitted client model weights; and further updating the client ML model using the updated server model weights.

Implementations of the disclosure may include one or more of the following optional features. In some implementations, the client ML model is randomly initialized and/or the server ML model is randomly initialized. In some examples, the client ML model is trained locally on the client device using the client training data that is exclusively stored on the client device. In these examples, the client training data may include sensitive data corresponding to the client device.

In some implementations, the operations further include obtaining, from the server, the server model weights at a predetermined interval. In these implementations, the predetermined interval includes a time period or a number of training steps. In some examples, the operations also include causing the server to update the server ML model by transmitting, to the server, client ML model weights of the client ML model. The client ML model may include a local hotword detection model.

Another aspect of the disclosure provides a system that includes data processing hardware and memory hardware storing instructions that when executed on the data processing hardware causes the data processing hardware to perform operations. The operations include training a client machine learning (ML) model on client training data at a client device. While training the client ML model, the operations also includes obtaining, from a server, server model weights of a server ML model trained on server training data, the server training data different that the client training data. While training the client ML model, the operations also include: transmitting, to the server, client model weights of the client ML model; updating the client ML model using the server model weights; obtaining, from the server, updated server model weights of the server ML model, the updated server model weights updated based on the transmitted client model weights; and further updating the client ML model using the updated server model weights.

Implementations of the disclosure may include one or more of the following optional features. In some implementations, the client ML model is randomly initialized and/or the server ML model is randomly initialized. In some examples, the client ML model is trained locally on the client device using the client training data that is exclusively stored on the client device. In these examples, the client training data may include sensitive data corresponding to the client device.

In some implementations, the operations further include obtaining, from the server, the server model weights at a predetermined interval. In these implementations, the predetermined interval includes a time period or a number of training steps. In some examples, the operations also include causing the server to update the server ML model by transmitting, to the server, client ML model weights of the client ML model. The client ML model may include a local hotword detection model

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for co-distillation for mixing server-based and federated learning.

FIG. 2 is a schematic view of an example co-distillation training process.

FIG. 3 a flowchart of an example arrangement of operations for a method of co-distillation for mixing server-based and federated learning.

FIG. 4 is a schematic view of an example computing device that may be used to implement the systems and methods described herein.

Like reference symbols in the various drawings indicate like elements.

### DETAILED DESCRIPTION

Federated learning performs decentralized machine learning (ML) model training and computation on a client device using locally stored data. Federated learning allows for privacy of client data by enabling local ML model training and computation without requiring transmission of potentially sensitive client data to a server. However, ML models trained using federated learning require input from a server-based dataset in addition to the client data to achieve competitive quality ML models. There are many known techniques for combining federated and centralized learning, such as utilizing gradients to update weights at the various models. However, these known techniques have many drawbacks, such as the risk of catastrophic forgetting as well as difficulty in tuning these techniques for various uses due to a large number of parameters that must be separately optimized for each use case.

Distillation is a meta-algorithm for training multiple ML models which allows any algorithm to incorporate some of the model quality benefits of ensembles. Distillation involves first training a teacher model, which traditionally includes an ensemble or another high-capacity model, and then, once this teacher model is trained, training a student model with an additional term in the loss function which encourages its predictions to be similar to the predictions of the teacher model. There are many variants of distillation for different types of teacher models, different types of loss functions, and different choices for what dataset the student model trains on. For example, the student model could be trained on a large unlabeled dataset, on a held-out data set, or even on the original training set. Perhaps surprisingly, distillation has benefits even if the teacher model and the student model are two instances of the same neural network, as long as they are sufficiently different (say, by having different initializations and seeing training examples in a different order). However, distillation cannot be directly adapted to federated learning as in federated learning a client ML model is generally the same architecture as a corresponding server ML model.

Implementations herein include co-distillation techniques for concurrently training the client ML model and the server ML model in a federated learning system. Importantly, at least some of the co-distillation techniques implement the same architecture for all the models (i.e., the client ML model and the server ML model). Further, co-distillation does not require a fully trained model as a teacher model. Instead, the co-distillation techniques only require the predictions of the corresponding ML models, which can be computed locally from copies of using weights of the respective ML model.

Implementations herein are further directed toward co-distillation for mixing server-based and federated learning. More specifically, a client machine learning (ML) model is initialized and trained locally at a client device using federated learning for a predetermined interval. At the predetermined interval, and while training the client ML model, the client device obtains one or more server model weights of a server ML model and/or transmits one or more client model weights of the client ML model to the server. The client device may then update the client ML model using the server model weights. The process may continue until the server ML model and the client ML model converge.

Co-distillation provides the benefits of distilling an ensemble of models without increasing training time. Further, co-distillation is also relatively simple to implement compared to a multi-phase distillation training procedure. Multi-phase distillation tends to encourage human intervention between the training phases to decide when to stop training the ensemble and start distilling it into a single model. By contrast, co-distillation does not require human overview and/or intervention. Co-distillation does not lose the reproducibility benefits of ensembles of neural networks, reducing churn in the predictions of different retrains of the same model. Reducing prediction churn can be beneficial when testing and launching new versions of a model without disrupting an existing service.

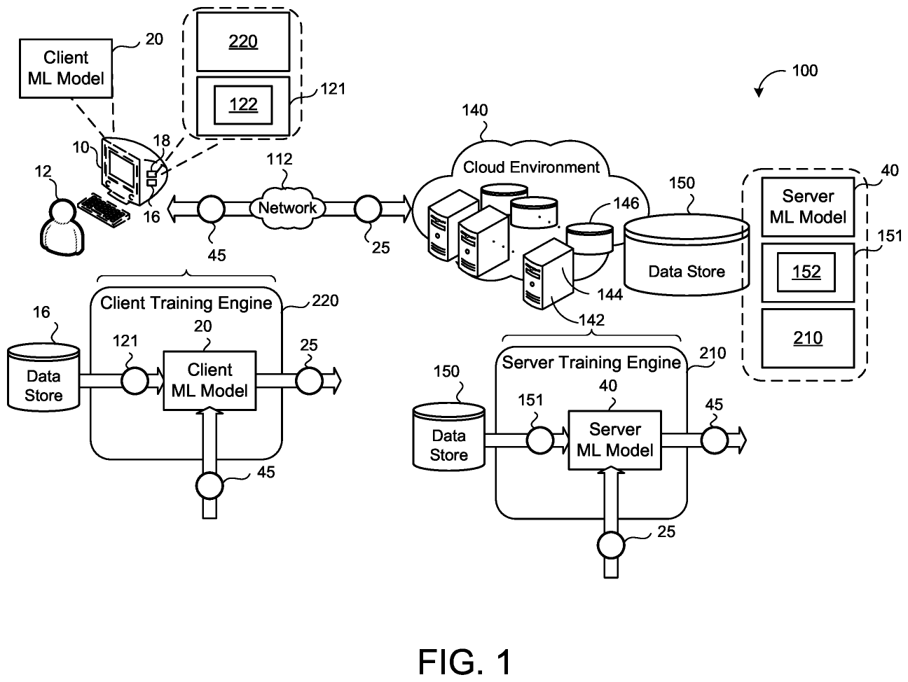

Referring to FIG. 1, in some implementations, an example co-distillation system 100 includes a server 140 (e.g., a high-performance remote server or cluster of high-performance remote servers) in communication with one or more user/client devices 10 via a network 112. The server 140 may be a single computer, multiple computers, or a distributed system (e.g., a cloud environment) having scalable/elastic resources 142 including computing resources 144 (e.g., data processing hardware) and/or storage resources 146 (e.g., memory hardware). The server 140 may be configured to train a server machine learning (ML) model 40 using a set of training data 151 including a plurality of training samples 152. A data store 150 (i.e., a remote storage device) may be overlain on the storage resources 146 to allow scalable use of the storage resources 146 by one or more of the clients (e.g., a user device 10) or the computing resources 144. The data store 150 is configured to store the plurality of training samples 152 of the set of training data 151. The data store 150 may also store the server ML model 40 and a server training engine 210 for training the server ML model 40.

The client device 10 may be communicatively coupled to the server 140 via the network 112. The client device 10 may correspond to any computing device, such as a desktop workstation, a laptop workstation, or a mobile device (i.e., a smart phone). The client device 10 includes computing resources 18 (e.g., data processing hardware) and/or storage resources 16 (e.g., memory hardware). The client device 10 may be configured to train a client ML model 20 via a client training engine 220. In some implementations, the client training engine 220 implements federated learning techniques to train the client ML model 20. In other words, the client training engine 220 trains the client ML model 20 locally on the client device 10 using client training data 121 which includes a plurality of client training samples 122. The client training data 121 may be sensitive data corresponding to the client device 10 or a user 12 that is stored locally at the client device 10 (e.g., at memory hardware 16) and not shared outside of the client device 10.

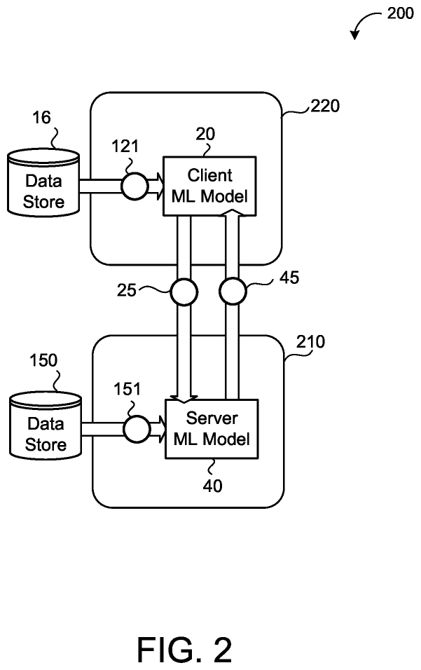

The server 140 is configured to obtain client model weights 25 of the client machine learning (ML) model 20 from, for example, the client device 10 associated with a respective user 12 via the network 112. In some implementations, the client model weights 25 are representative of a state of the client ML model 20 after a predetermined training interval is complete. In some implementations, the client device 10 only transmits client model weights 25 of the client ML model 20 (and/or other relevant portions of the client ML model 20) that are not trainable. In other words, the client device 10 does not transmit or share client model weights 25 that are trainable or that will continue to change throughout training of the client ML model 20. Upon receiving the client model weights 25, the server 140, via the server training engine 210, may update the server ML model 40 based on the client model weights 25, as discussed in greater detail below (FIG. 2).

In some implementations, the client device 10 is configured to obtain server model weights 45 of the server machine learning (ML) model 40 from, for example, the server 140. The server ML model 40 may be trained on global training data (i.e., the server training data 151) via the server training engine 210. In some implementations, the server model weights 45 are representative of a state of the server ML model 40 after a predetermined training interval is complete. In some implementations, the server 140 only transmits server model weights 45 of the server ML model 40 (and/or other relevant portions of the server ML model 40) that are not trainable. In other words, the server 140 does not transmit or share server model weights 45 that are trainable or that will continue to change throughout training of the server ML model 40. Upon receiving the server model weights 45, the client device 10, via the client training engine 220, may update the client ML model 20 based on the server model weights 45, as discussed in greater detail below (FIG. 2)

In some implementations, the client ML model 20 that is stored in on-device memory of the client device 10 (e.g., the client ML model 20 is stored in the memory hardware 16), can be a local counterpart of the corresponding server ML model 40 (stored on the memory hardware 146, or more specifically at the data store 150 overlain on the memory hardware 146 of the server 140). In some implementations, the client device 10 and/or the server 140 are configured to transmit that model weights 25, 45 between any of the client devices 10 and/or server 140 of the system 100. Notably, the server ML model 40 may be initially trained by the server 140 (e.g., via a server training engine 170) and based on the set of training data 151 stored at the server 140 (e.g., at the data store 150). In some implementations, the server ML model 40 is transmitted to the client device 10 and then further trained using federated learning techniques to generate the client ML model 20 (e.g., further trained on the client training data 121 locally on the client device 10). In other words, the client device 10 may store and fine-tune (using local data) the server ML model 40 in corresponding on-device storage 16 as the client ML model 20 in a federated manner as described herein. The client training data 121 may include confidential/sensitive data that is to remain securely stored on the client device 10.

In other implementations, the client ML model 20 is initialized locally on the client device 10 and the server ML model 40 is initialized locally on the server 140. In some implementations, the server ML model 40 and the client ML model 20 are constructed with the same architecture (i.e., though initialized independently, the ML models 20, 40 have the same architecture). Accordingly, the client ML model 20 and the server ML model, after sufficient training, can converge.

The ML models 20, 40 may include any known or developed machine learning models that can be honed using federated learning techniques. For example, the ML models 20, 40 include a supervised learning model, a reinforcement learning model, a hybrid learning model, a regression model, etc. In some examples, the ML models 20, 40 include various audio-based ML models that are utilized to process audio data generated locally at the client device 10, various vision-based ML models that are utilized to process vision data captured/generated locally at the client device 10 and/or any other ML model that may be trained in the federated manner.

For example, assume that the server ML model 40 corresponds to a global hotword detection model. The server ML model 40 is transmitted to the client device 10 to be further trained using federated learning techniques on the set of client training data 121. In this example, the client device 10 may store the global hotword detection model as the client ML model 20 (i.e., a local hotword detection model) that is a local counterpart (i.e., local to the client device 10) of the server hotword detection model (i.e., the server ML model 40). By storing the global hotword detection model locally as the client ML model 20, the client device 10 may optionally replace a prior instance of the local hotword model (or one or more local weights thereof) with the global hotword detection model (or one or more global weights thereof). Further, the client device 10 can process audio data (e.g., as the set of client training data 121), using the local hotword detection model, to generate a prediction of whether the audio data captures a particular word or phrase (e.g., “Assistant”, “Hey Assistant”, etc.) that, when detected, causes an automated assistant executing at least in part at the client device 10 to be invoked as the predicted output(s). The prediction of whether the audio data captures the particular word or phrase can include a binary value of whether the audio data is predicted to include the particular word or phrase, a probability or log likelihood that of whether the audio data is predicted to include the particular word or phrase, and/or other value(s) and/or measure(s).

As another example, assume that a server ML model 40 corresponds to a global hotword free invocation model that is received at the client device 10 from the server 140. In this example, the client device 10 may store the global hotword free invocation model as the client ML model 20 that is a local counterpart (i.e., local to the client device 10) of the global hotword detection model in the same or similar manner described with respect to the above example. Further, the client device 10 can process vision data (e.g., as the set of client training data 121), using the local hotword free invocation model, to generate a prediction of whether the vision data captures a particular physical gesture or movement (e.g., lip movement, eye gaze, etc.) that, when detected, causes the automated assistant executing at least in part at the client device to be invoked as the predicted output(s). The prediction of whether the vision data captures the particular physical gesture or movement can include a binary value of whether the vision data is predicted to include the particular physical gesture or movement, a probability or log likelihood that of whether the vision data is predicted to include the particular physical gesture or movement, and/or other value(s) and/or measure(s).

The system of FIG. 1 is presented for illustrative purposes only and is not intended to be limiting. For example, although only a single example of each component is illustrated, the system 100 may include any number of components 10, 140, 150, 210 and 220. Further, although some components are described as being located in the server, in some implementations, some or all of the components may be hosted locally on the client device 10. Further, in various implementations, some or all of the components 150 and 200, are hosted locally on client device 110, remotely (such as in the server 140), or some combination thereof.

FIG. 2 illustrates an example co-distillation training process 200. The co-distillation training process trains two models (e.g., the client ML model 20 and the server ML model 40) separately and in parallel. In some implementations the co-distillation training process 200 begins with the client ML model 20 initialized independently at the client device 10 (FIG. 1) and a server ML model 40 initialized independently at the server 140 (FIG. 1). In other implementations, the server ML model 40 is initialized and partially or fully trained on server training data 151 and then transmitted to the client device 10. The client device 10 may then begin training the received server ML model 40 using federated learning techniques to develop a client ML model 20 personalized and refined on client training data 121.

The co-distillation training process 200 may train the client ML model 20 locally at the client device 10 using client training data 121 that includes client training samples 122 (e.g., via the client training engine 220). The client training data 121 may be sensitive data corresponding to the client device 10 that is securely stored locally on the client device 10. In parallel, the co-distillation training process 200 may begin/continue training the server ML model 40 on the server training data 151 including server training samples 152 (e.g., via the server training engine 210). The co-distillation training process 200 may continue to train the ML models 20, 40 in parallel for a predetermined interval. The predetermined interval may be based on a number of training cycles (e.g., a number of training samples 122, 152 provided to the respective ML model 20, 40), a time period/length of time, or any other appropriate interval. At the predetermined interval, the client training engine 220 may obtain server model weights 45 from the server ML model 40. Further, at the predetermined interval, the server training engine 210 may obtain the client model weights 25 from the client ML model 20. The model weights 25, 45 may be exchanged at the same time or at different times depending on how the predetermined interval is configured and/or the communications between the client device 10 and the server 140.

The client training engine 220 may update the client ML model 20 with the server model weights 45. In some implementations, the server model weights 45 are non-trainable weights that will no longer be updated during the co-distillation training process 200. By updating the client ML model 20 with the server model weights 45, the client ML model 20 will produce different outputs for each client training sample 122 during training compared to a non-updated client ML model 20. Accordingly, the client ML model 20 will be influenced by the server ML model 40.

Additionally or alternatively, the server training engine 210 updates the server ML model 40 with the client model weights 25. In some implementations, the client model weights 25 are non-trainable weights that will no longer be updated during the co-distillation training process 200. By updating the server ML model 40 with the client model weights 25, the server ML model 40 will produce different outputs for each server training sample 152 during training compared to a non-updated server ML model 40. Accordingly, the server ML model 40 will be influenced by the client ML model 20.

The co-distillation training process 200 expedites training for each of the ML models 20, 40, as each ML model 20, 40 benefits from the training of the other respective ML model 20, 40 when updated with the respective model weights 25, 45. Further, the co-distillation training process 200 includes continuous exchange of the client model weights 25 and the server model weights 45 at each of any number of predetermined intervals. In this manner, as each ML model 20, 40 improves with additional training, the model weights 25, 45 can be shared as an updated reflection of the current state of the respective ML model 20, 40. The co-distillation training process 200 may continue for a set number of pre-defined intervals, for a set length of time, until each of the ML models 20, 40 have been trained on the respective training data set 121, 151, until the ML models 20, 40 converge, or until some other appropriate point in time. The two ML models 20, 40 may converge when they each reach respective stable parameter values with consistently good performance. Thus, the two ML models 20, 40 may converge to separate model weights that are each stable and have consistently good performance.

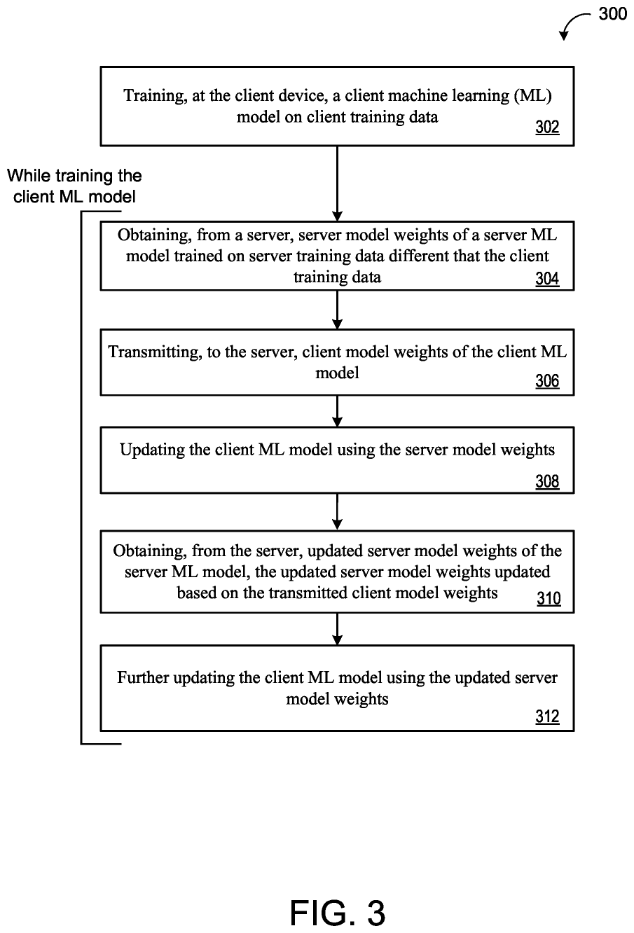

FIG. 3 is a flowchart of an exemplary arrangement of operations for a method 300 of co-distillation for mixing server-based and federated learning. The operations for the method 300 may execute on the data processing hardware 16 of the client device 10 of the co-distillation system 100 of FIG. 1. At operation 302, the method 300 includes training, at the client device 10, a client machine learning (ML) model 20 on client training data 121.

While training the client ML model 20, the method 300 performs operations 304-312. At operation 304, the method 300 includes obtaining, from a server 140, server model weights 45 of a server ML model 40 trained on server training data 151 different than the client training data 121. At operation 306, the method 300 includes transmitting, to the server 140, client model weights 25 of the client ML model 20. At operation 308, the method 300 includes updating the client ML model 20 using the server model weights 45. At operation 310, the method 300 includes obtaining, from the server 140, updated server model weights 45 of the server ML model 40, the updated server model weights 45 updated based on the transmitted client model weights 25. At operation 312, the method 300 includes further updating the client ML model 20 using the updated server model weights 45.

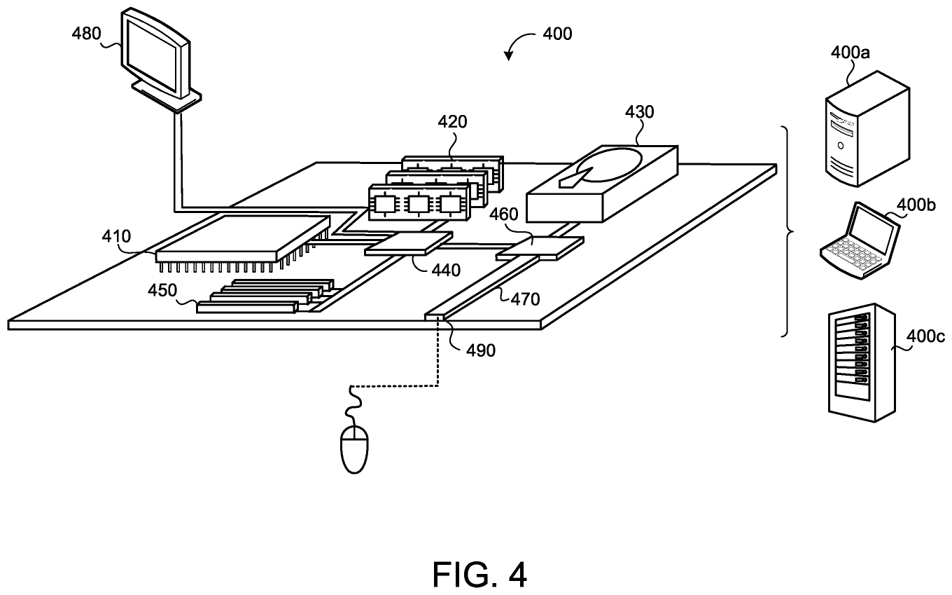

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware of a client device that causes the data processing hardware to perform operations comprising:
training, at the client device, a client machine learning (ML) model on client training data; and
while training the client ML model:
obtaining, from a server, server model weights of a server ML model trained on server training data, the server training data different that the client training data; and
transmitting, to the server, client model weights of the client ML model;
updating the client ML model using the server model weights;
obtaining, from the server, updated server model weights of the server ML model, the updated server model weights updated based on the transmitted client model weights; and
further updating the client ML model using the updated server model weights.

2. The method of claim 1, wherein the client ML model is randomly initialized.

3. The method of claim 1, wherein the server ML model is randomly initialized.

4. The method of claim 1, wherein the client ML model is trained locally on the client device using the client training data that is exclusively stored on the client device.

5. The method of claim 4, wherein the client training data comprises sensitive data corresponding to the client device.

6. The method of claim 1, wherein the operations further comprise obtaining, from the server, the server model weights at a predetermined interval.

7. The method of claim 6, wherein the predetermined interval comprises a time period.

8. The method of claim 6, wherein the predetermined interval comprises a number of training steps.

9. The method of claim 1, wherein the operations further comprise causing the server to update the server ML model by transmitting, to the server, client ML model weights of the client ML model.

10. The method of claim 1, wherein the client ML model comprises a local hotword detection model.

11. A system comprising:
data processing hardware of a client device; and
memory hardware in communication with the data processing hardware, the memory hardware storing instructions that when executed on the data processing hardware cause the data processing hardware to perform operations comprising:
training, at the client device, a client machine learning (ML) model on client training data; and
while training the client ML model:
obtaining, from a server, server model weights of a server ML model trained on server training data, the server training data different that the client training data; and
transmitting, to the server, client model weights of the client ML model;
updating the client ML model using the server model weights;
obtaining, from the server, updated server model weights of the server ML model, the updated server model weights updated based on the transmitted client model weights; and
further updating the client ML model using the updated server model weights.

12. The system of claim 11, wherein the client ML model is randomly initialized.

13. The system of claim 11, wherein the server ML model is randomly initialized.

14. The system of claim 11, wherein the client ML model is trained locally on the client device using the client training data that is exclusively stored on the client device.

15. The system of claim 14, wherein the client training data comprises sensitive data corresponding to the client device.

16. The system of claim 11, wherein the operations further comprise obtaining, from the server, the server model weights at a predetermined interval.

17. The system of claim 16, wherein the predetermined interval comprises a time period.

18. The system of claim 16, wherein the predetermined interval comprises a number of training steps.

19. The system of claim 11, wherein the operations further comprise causing the server to update the server ML model by transmitting, to the server, client ML model weights of the client ML model.

20. The system of claim 11, wherein the client ML model comprises a local hotword detection model.
